(19) United States
(12) Patent Application Publication
(10) Pub. No.: US 2018/0277289 A1
(43) Pub. Date: Sep. 27, 2018

(54) Inverse Phase Allotrope Rare Earth Magnets

(71) Applicant: Intermolecular, Inc., San Jose, CA (US)

(72) Inventor: Abraham Anapolsky, San Mateo, CA (US)

(73) Assignee: Intermolecular, Inc., San Jose, CA (US)

(21) Appl. No.: 15/782,062

(22) Filed: Oct. 12, 2017

Related U.S. Application Data
(60) Provisional application No. 62/474,197, filed on Mar. 21, 2017.

(51) Int. Cl. H01F 1/055; H01F 1/11; H01F 1/09; H01F 41/22; H01F 41/02

(52) U.S. Cl. CPC H01F 1/0551; H01F 1/11; H01F 41/0266; H01F 1/0556; H01F 41/22; H01F 1/09

(57) ABSTRACT

Provided are inverse phase allotrope rare earth (IPARE) magnets, methods of forming thereof, and applications of IPARE magnets. Unlike conventional samarium-cobalt magnets, IPARE magnets maintain their hexagonal lattice structures over a range of equiatomic compositions, such as when concentrations of different elements are within 10 atomic % of each other. An IPARE magnet may comprise cobalt, iron, copper, nickel, and samarium and a concentration of cobalt may be between 17-27 atomic %. An IPARE magnet may be substantially free from zirconium and/or titanium. An IPARE magnet may be formed by quenching a molten mixture of its components. The quenching may be performed in a magnetic field. After quenching, the IPARE magnet may be machined. Furthermore, IPARE magnets may be used as a structural element, e.g. in an electric motor.

### CROSS-REFERENCE TO RELATED APPLICATIONS

This application claims the benefit under 35 U.S.C. § 119(e) of U.S. Provisional Patent Application 62/474,197, entitled: “Inverse Phase Allotrope Rare Earth Magnets” filed on Mar. 21, 2017 (Attorney Docket No. IM1933 US V), which is incorporated herein by reference in its entirety

### BACKGROUND

Permanent magnets have various applications, such as conversion of electrical energy to mechanical energy (in electrical motors) and vice versa (in generators). The maximum magnetic energy product (BHₘₐₓ) is a measure of the available energy per unit mass or volume of a permanent magnet. Depending upon the duty requirements, operating environment, size/weight constraints, and other factors, selected permanent magnets may not have the highest magnetic energy product. Furthermore, most conventional permanent magnets, in particular rare earth magnets, such as samarium-cobalt magnets and neodymium iron boron magnets, suffer from poor mechanical properties. Specifically, many of these magnets are very brittle and difficult to machine (after casting) to meet various dimensional tolerances for magnetic circuits and applications. These aspects limit applications of these magnets. For example, samarium-cobalt magnets cannot be used as load bearing components or structural components. In addition, the brittleness of many permanent magnets limits available shapes and dimensions that can be used for these magnets.

### SUMMARY

Provided are inverse phase allotrope rare earth (IPARE) magnets, methods of forming thereof, and applications of IPARE magnets. Unlike conventional samarium-cobalt magnets, IPARE magnets maintain their hexagonal lattice structures over a range of equiatomic compositions, such as when concentrations of different elements are within 10 atomic % of each other or even within 5 atomic % in some embodiments. The IPARE magnets described herein are solid solution. As such, the IPARE magnets represent a new class of permanent magnets containing multiple different elements around equiatomic concentrations. One unique characteristic of these IPARE magnets is enhanced mechanical toughness.

An IPARE magnet may comprise cobalt, iron, copper, nickel, and samarium. The concentration of cobalt may be between 17-27 atomic %, which is much lower than in conventional samarium-cobalt magnet. In some embodiments, the IPARE magnet may be substantially free from zirconium and/or titanium.

The IPARE magnet may be formed by quenching a molten mixture of its components. The quenching may be performed in a magnetic field. After quenching, the IPARE magnet may be machined, due to their toughness. Furthermore, IPARE magnets may be used as a structural element, e.g., in an electric motor.

In some embodiments, an IPARE magnet comprises cobalt, iron, copper, nickel, and samarium. The concentration of cobalt may be between about 17 atomic % and 27 atomic % or, more specifically, between about 20 atomic % and 25 atomic %. The concentration of iron may be between about 18 atomic % and 24 atomic %. The concentration of copper may be between about 17 atomic % and 27 atomic %. The concentration of nickel may be between about 18 atomic % and 24 atomic %. The concentration of samarium may be between about 12 atomic % and 20 atomic %.

| Element | Range | Subrange |
|---|---|---|
| Cobalt, at % | 17-27 | 20-25 |
| Iron, at % | 18-24 | 20-24 |
| Copper, at % | 17-27 | 17-20 |
| Nickel, at % | 18-24 | 18-21 |
| Samarium, at % | 12-20 | 15-19 |

The IPARE magnet may be a solid solution. For purposes of this disclosure, a solid solution is defined as a material with a structure being disordered on at least one sub-lattice. Furthermore, the IPARE magnet may have a hexagonal or other uniaxial lattice structure. In some embodiments, the IPARE magnet may have a grain size of between about 100 nm and 20,000 nm or, more specifically, between about 100 nm and 10,000 nm.

Also provided is a method of forming an IPARE magnet. The method may comprise forming a mixture comprising cobalt, iron, copper, nickel, and samarium. The concentration of cobalt in the mixture may be between about 17 atomic % and 27 atomic %. The method then proceeds with melting the mixture to form a molten alloy. Finally, the method involves quenching the molten alloy to form a solid structure of the IPARE magnet. In some embodiments, quenching the molten alloy comprises exposing the molten alloy to a magnetic field. The method may comprise heat treating the solid structure of the IPARE magnet. In some embodiments, the method further comprises machining the solid structure of the IPARE magnet.

Also provided is a component comprising an IPARE magnet. Various examples and methods of forming the IPARE magnet is presented above. In some embodiments, the IPARE magnet comprises cobalt, iron, copper, nickel, and samarium. The concentration of cobalt in the IPARE magnet may be between about 17 atomic % and 27 atomic %. The component may be one of a motor, a generator, a sensor, an actuator, a medical device, magnetic gears, magnetic bearings, magnetic separation equipment, acoustic devices, latches, and holding and lifting equipment.

### BRIEF DESCRIPTION OF THE DRAWINGS

FIG. 1 is a process flowchart corresponding to a method of forming an IPARE magnet, in accordance with some embodiments.

FIG. 2 is a simulation of SmX (1-5) X-ray Diffraction (XRD) spectra with near equiatomic compositions of cobalt, copper, iron, and nickel showing identical spectra to SmCo₅ conventional magnets.

FIG. 3 is diffraction spectra for 1-5 alloys showing identical structure for a range of compositions.

FIG. 4 illustrates properties of a high-coercivity, non-brittle, as-cast alloys.

FIG. 5 illustrates a plot of the sum of copper and nickel vs. the volume fraction of B-phase and BHₘₐₓ.

FIGS. 6 and 7 illustrate an example of composition analysis of one alloy sample at two locations.

FIGS. 8A and 8B illustrates gravimetric calorimetry (with a magnetic field) and differential scanning calorimetry data used for determining Curie temperatures and any phase transformations.

FIG. 9 shows the result of an annealing experiment for one of the alloys.

FIGS. 10A-10C are plots showing dependence of composition on grain size.

FIGS. 11A-11C illustrate magnetic properties as a function of temperature.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

Provided are IPARE magnets and methods of fabricating thereof. As noted above, unlike conventional samarium-cobalt magnets, IPARE magnets maintain their hexagonal lattice structures over a range of equiatomic compositions and represent a new class of permanent magnets. One unique characteristic of these IPARE magnets is enhanced mechanical toughness in comparison to conventional magnets such as neodymium-iron-boron (Nd—Fe—B) magnets, samarium-cobalt (Sm—Co) magnets, Ferrite magnets, and Alnico magnets. For example, Sm—Co and Nd—Fe—B magnets are intrinsically brittle, which rules out casting the magnets to a finished net shape. As such, IPARE magnets can be cast and machined, which in turn allows to produce large (e.g., at least 10 kg magnets) for new applications, such as mega-Watt scale wind generation. Specifically, IPARE magnets were successfully tested for hole drilling with a carbide drill or cutting cubes from larger cubes. Such machining is not possible with conventional samarium-cobalt magnets. Furthermore, IPARE magnets may have moderate magnetic energy density (e.g., 9-20 MGOe), good corrosion resistance, Curie temperature >700° C., and desired cost-to-performance ratio at operating temperature of 150° C.

The IPARE magnets may be solid solutions with a random arrangement of atoms on one or more (sub-) crystal lattices. Specifically, the IPARE magnets may have a hexagonal or other uniaxial crystal structure. In a solid solution, a structure is disordered on at least one sub-lattice.

It should be also noted that cobalt is generally more expensive than iron, copper, and nickel. Therefore, the cost of IPARE magnets may be cheaper than conventional samarium-cobalt magnets because of a much lower concentration of cobalt in the IPARE magnets. Furthermore, additional cost savings may be realized by utilizing different processes to form IPARE magnets and in particular availability of melting and casting, and post-casting machining (drilling, milling, etc.), instead of powder metallurgy.

As noted above, an IPARE magnet comprises copper, iron, nickel, and samarium, in addition to cobalt. Concentrations of all of these elements may be within 10 atomic % from each other or, more specifically, within 5 atomic % in such embodiment.

The concentration of cobalt may be between about 17 atomic % and 27 atomic % or, more specifically, between 20 atomic % and 25 atomic %, such as about 24 atomic % and 25 atomic %. The concentration of iron may be between about 18 atomic % and 24 atomic % or, more specifically, between 20 atomic % and 24 atomic %, such as between about 23 atomic % and 24 atomic %. The concentration of copper may be between about 17 atomic % and 27 atomic % or, more specifically, between 17 atomic % and 20 atomic %, such as between about 17 atomic % and 18 atomic %. Without being restricted to any particular theory, it is believed that the copper concentration has an effect on grain size, which in turn has an effect on magnetic behavior. Furthermore, increasing the concentration of copper in the IPARE magnet improves its toughness. The concentration of nickel may be between about 18 atomic % and 24 atomic % or, more specifically, between 18 atomic % and 21 atomic %, such as between about 18 atomic % and 19 atomic %. Finally, the concentration of samarium may be between about 12 atomic % and 20 atomic % or, more specifically, between 15 atomic % and 19 atomic %, such as between about 15 atomic % and 17 atomic %.

| Element | Range | Subrange | Narrower Subrange |
|---|---|---|---|
| Cobalt, at % | 17-27 | 20-25 | 24-25 |
| Iron, at % | 18-24 | 20-24 | 23-24 |
| Copper, at % | 17-27 | 17-20 | 17-20 |
| Nickel, at % | 18-24 | 18-21 | 18-19 |
| Samarium, at % | 12-20 | 15-19 | 15-17 |

In some embodiments, an IPARE magnet may include at least one of niobium, beryllium, boron, platinum, silver, which may be referred to as additives. One of their functions might be to control grain size, yet another function might be to control remanence, or coercivity. The concentration of one or more of these additives may be between about 1 atomic ppm and 2.0 atomic % or, more specifically, between 10 atomic ppm and 0.5 atomic %, such as about 0.1 atomic %. These additives may be used to control oxygen, refine magnetic domain boundaries, and/or decrease grain size. When one or more of these additives are presented in an IPARE magnet, the concentrations of cobalt, copper, iron, nickel, and samarium may be proportionally scaled down. Furthermore, in some embodiments other rare earth elements, e.g., praseodymium (Pr), neodymium (Nd), europium (Eu), gadolinium (Gd), terbium (Tb), dysprosium (Dy), holmium (Ho), and erbium (Er), may partially or completely replace samarium. These rare-earth elements might be present as one rare-earth element, two rare-earth elements, or multiple rare-earth elements.

In some embodiments, IPARE magnets are substantially free from zirconium and/or titanium. Without being restricted to any particular theory, it is believed that addition of zirconium and/or titanium to an IPARE magnet may cause phase separation and reduce disorder (i.e., starts forming an ordered lattice) of the solid-state solution of the magnet. The concentration of zirconium and/or titanium may be less than 0.5 atomic % or even less than 0.1 atomic %.

Magnet coercivity strongly depends on the grain size (crystal size) forming these magnets. For small grain sizes, the ability to couple together is minimal. For large grain sizes, there is an inherent drive to demagnetize into separate domains. For samarium-cobalt magnets, the maximum coercivity is achieved with a grain size of about 200 nanometers. However, achieving this grain size is difficult and generally not possible using conventional techniques. Specifically, quenching a molten alloy generally cannot be done fast enough (the quenching rates are limited by various factors, such as heat transfer, etc.) to achieve the desired grain size. High quenching may be needed in conventional magnets, for example, to set the non-equilibrium phase in SmCo₅. As a result, a conventional process involves forming particles from a solidified alloy block, milling these particles to about 200-5,000 nanometer size (D50), pack the milled particles into a mold while subjecting these particles to a magnetic field for alignment, and sintering these particles into a new block representing final shape (and often dimensions) of the magnet. However, the intergranular bonds (particle to particle) in the sintered magnets are very weak. As such, sintered bonds have very poor mechanical properties.

IPARE magnets are formed using different processes, as further described below. In some embodiments, an IPARE magnet has a grain size of between about 100 nm and 20,000 nm or, more specifically, between about 100 nm and 10,000 nm right after quenching. Small effective grain size may also be achieved by precipitation of a secondary phase, and or crystal defects, either intrinsic or imposed by processing. Other grain size refinement methods are hot rolling, adding grain size refiners to control nucleation and growth. In some embodiments, grain size control techniques, such as stirring in melt during cooling, controlled cooling, hot rolling, friction stirring, introducing additives to increase nucleation sites and/or act as grain refiners, powder metallurgy, may be used.

Another characteristic of IPARE magnets is their corrosion resistance. For example, conventional Sm—Co alloys exhibit better corrosion resistance than NdFeB. Just as conventional Sm—Co alloys, these IPARE magnets are expected to have better corrosion resistance than NdFeB.

### Processing Examples

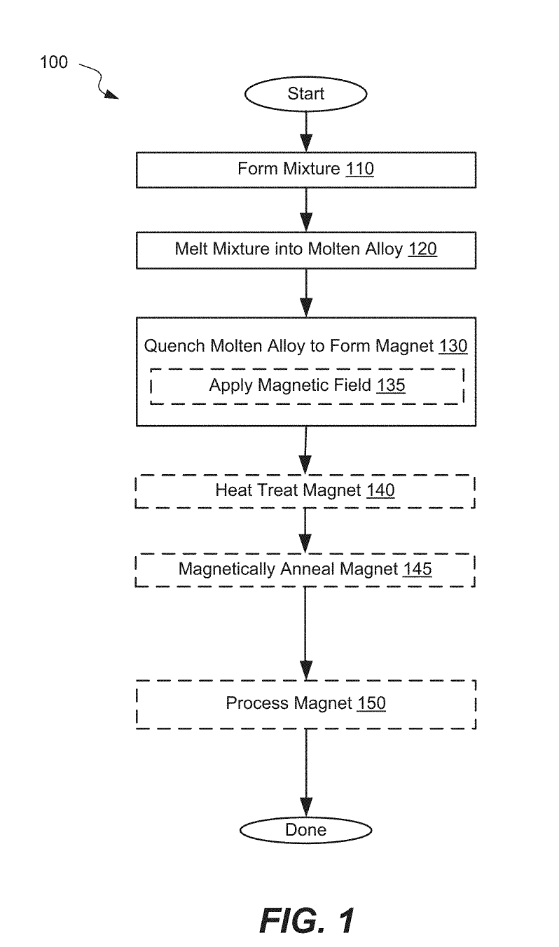

FIG. 1 is a process flowchart corresponding to method 100 of IPARE magnets, in accordance with some embodiments. Method 100 may commence with forming a mixture during operation 110. The mixture comprises cobalt, iron, copper, nickel and samarium. The composition of this mixture is the same as the composition of the resulting IPARE magnet, various examples of which are presented above. It should be noted that some Sm might be lost during processing. The mixture may be formed by mixing together pieces containing the above referenced elements, e.g. ingots, rods, chunks, powders, cylinders, blocks, or the like.

Method 100 proceeds with melting the mixture into a molten alloy during operation 120. For example, the mixture may be heated to a temperature of between about 1700 and 2000 degrees Celsius or, more specifically, between about 1800 and 1900 degrees Celsius.

IPARE magnet elements can be mixed by arc or induction melting pieces of the elements or alloys, and either quenched in melting crucible or cast, e.g. into final shape. IPARE magnets can be also made by strip casting. Furthermore, IPARE magnets can be made by powder metallurgy, where the powder can be made by gas atomization, or size reduction techniques like wet/dry milling, followed by powder consolidation techniques like hot isostatic pressing (HIP) techniques.

Method 100 proceeds with quenching the molten alloy into a solid structure, which represents an IPARE magnet, during operation 130. Unlike conventional magnet processing where it is common for the alloy to shatter on cooling, IPARE alloys can be cast to near their net shapes, while the resulting solid structures remain monolithic during operation 130 and do not shatter. Furthermore, fast quenching rates (e.g., minutes/1000° C.) often used during production of conventional magnets are not needed for IPARE magnets. Without being restricted to any particular theory, it is believed that the 1-5 phase is thermodynamically stable in such magnets over a wide temperature range, e.g., down to room temperature.

In some embodiments, operation 130 may involve applying a magnetic field to the molten alloy prior to and during the quenching operation, as reflected by block 135 in FIG. 1. In these embodiments, the alloy is solidified at a rapid (seconds) or slow (hours) rate in the presence of a substantial magnetic field of 2000 to 20000 Gauss. The magnetic field is aligned in such a way that the magnet can achieve a substantial fraction of the materials theoretical remanent magnetization. It should be noted that operation 135 is optional and in some cases, no magnetic field may be applied during quenching. Operation 130 may be also referred to as an aligning technique. Other examples of such aligning techniques include hot rolling, hot forging, sintering platelets, and the like.

In some embodiments, various grain size reduction techniques may be used in one or more operations of method 100. For example, various additives (described above) may be added to the alloy to increase its nucleation sites and/or to act as grain refiners. In some embodiments, powder metallurgy may be used to form fine powders made by, for example, milling or atomization. Furthermore, stirring of the molten alloy may be performed during cooling. Furthermore, the cooling may be controlled, e.g., by a controlled cooling rate. The IPARE magnet may be hot rolled and/or friction stirred.

Method 100 may involve heat treating the IPARE magnet during optional operation 140. For example, the IPARE magnet may be heated at a rate of between about 0.1° C./minute to 10° C./minute a temperature between 1000° C. and 1150° C. The heat treatment may be used to anneal a type of defect that encourages demagnetization

Method 100 may involve magnetically annealing the magnet during optional operation 145. This operation may be performed in a DC field applied parallel to the desired direction of magnetization of the IPARE magnet. The field may be applied as the IPARE magnet is cooled from the melt. The cooling rates can be rapid or slow

Method 100 may proceed with processing the IPARE magnet during optional operation 150. Some examples of optional processing include, but are not limited to, machining (e.g., drilling or milling), compression bonding, thermo-mechanical processing (e.g. hot forming), surface finishing, and coating. Various carbide cutting tools may be used for this purpose. Unlike conventional magnets, which typically shatter during such processing, the IPARE magnet may be processed similar to stainless steel, INCONEL®, MONEL®, etc.

Another example of method 100 involves the following one or more operations: alloy preparation, pre-milling, milling, composition control and adjustment, particle alignment and pressing, sintering and heat treatment, machining, and magnetizing. The alloy preparation may involve vacuum induction melting or, more specifically, ingot casting or strip casting. The pre-milling involves size reduction (e.g., to less than 0.5 millimeters) prior to the final milling. For example, alloy cast lumps may be crushed, e.g., under a nitrogen atmosphere in a hammer mill. In some embodiments, chemical method of pre-milling is used (e.g., hydrogen decrepitation).

The milling is used to generate a narrow size distribution of single crystal particles, e.g., individual particles containing no grain boundaries and, as such, only one preferred axis of magnetization. Furthermore, high particle surface areas formed during the milling may be used for high sinter reactivity. For single phase magnets, where the coercivity is controlled by domain nucleation and wall pinning at grain boundaries, the particle size and surface condition determines the coercivity of the sintered magnet. Ball milling (e.g., in an organic liquid under an inert gas or, more specifically, attritor milling in cyclohexane) or jet milling may be used for this operation.

The particle alignment and pressing is used to obtain a powder compact with maximum magnetization. In these compacted particles, the axes of magnetization are parallel. The powder compaction may be performed by die pressing or by isostatic pressing. For example, the aligning magnetic field may be set up in the cavity of a non-magnetic die with its axis lying either in the direction of pressing or at right angles to the pressing direction. The degree of alignment may depend on the particle shape and particle size, magnitude of aligning field and pressing pressure.

The sintering and heat treatment may be performed in inert gas atmospheres or under vacuum. The density of magnets may increase (e.g., to at least 95% of the theoretical density) during this process with no appreciable grain growth. In some embodiments, the magnet may form fine and uniformly distributed precipitates that act as domain wall pinning sites. In these areas, the domain wall energy is much higher or much lower than that of the matrix phase.

The machining may be used to finalize the shape and size of the magnet, which may have changes during sintering operation. For example, magnets may be adhered to steel backing plates and ground using grinding machines fitted with either silicon carbide or diamond grinding wheels.

The magnetization may be performed prior to assembly without flux loss or during the system assembly. The magnetizing force used during this operation depends on the coercivity of the magnetic material and may also depend on physical characteristics of the magnet and surrounding components during this operation. A peak field of between 2 and 2.5 times the intrinsic coercivity may be used.

### Application Examples

IPARE magnets described herein can be used for motors, generators, sensors, actuators, medical devices, magnetic gears, magnetic bearings, load bearing structures, magnetic separation equipment, acoustic devices, latches, holding and lifting equipment, and the like. These applications are available due to unique mechanical properties of the IPARE magnets. Specifically, the IPARE magnets have high toughness allowing hole drilling, cutting, and shaping by machining.

### Experimental Results

Various compositions of IPARE magnets and other types of magnets, which are described above, have been tested using combinatorial thin film synthesis. Specifically, physical vapor deposition (PVD) was used to form test samples, by simultaneous sputtering using multiple targets, e.g., samarium-copper-cobalt, iron-copper, nickel, and cobalt-nickel-copper targets. Primary test samples were alloy systems such as CoᵥCu_{w}FeₓNi_{y}Sm_{z} with 17<v . . . y<25 and 12<z<17 atomic %.

Thin films of 1 micrometer thickness were deposited on silicon/silicon oxide wafers. Once deposited, these films were annealed in-situ at a temperature of up to 550° C. The characterization suite utilizes scanning electron microscopy (SEM), x-ray diffraction (XRD), x-ray photoelectron spectroscopy (XPS), energy dispersive spectroscopy (EDS), and transmission electron microscopy (TEM) with EDS. Magnetic characterization was done using a vibrating sample magnetometer (VSM).

The initial screening involved examining all near-equiatomic alloys that had coercivities ˜1 kOe. It has been found that as samarium content increases above 10 atomic %, and the combined content of nickel and copper decreases below 50 atomic %, there is a significant increase in coercivity of IPARE magnets.

Furthermore, bulk alloy samples were prepared with compositions having equiatomic concentrations of cobalt, copper, iron, and nickel with fixed concentrations of samarium of 12, 15, 16, and 17 atomic %. The casting was performed using arc melting in argon atmosphere using a tungsten cathode and a water cooled copper crucible. The bulk samples were then sawn and ground into small cubes (about 10-15 millimeters sides). The cubes were characterized before and after annealing in a flowing argon atmosphere for about 1 hour at approximately 1000° C.

In addition to various analytical techniques described above, the bulk samples were tested using electron backscatter diffraction (EBSD), hysteresisgraph for M-H data, micro-indentation, thermal gravimetric analysis (TGA), and differential scanning calorimetry (DSC). Both indentation and qualitative assessments were done to determine mechanical behavior, in particular toughness. For alloys containing no more than 27% of any element, ingots were casted without decrepitation or cracking upon cooling. Alloys of conventional SmCo₅ and Sm[CoCuFeZr]₇ formulations were also cast using the same technique but all such alloys have shattered upon cooling. Another qualitative assessment was made by machining the cubes with conventional tooling (i.e. carbide drill bits) on a drill press, with the samples clamped in a vice. The swarf from the drilling was examined and found to consist of flat chips, similar to what would be found upon machining a hard metal, such as steel.

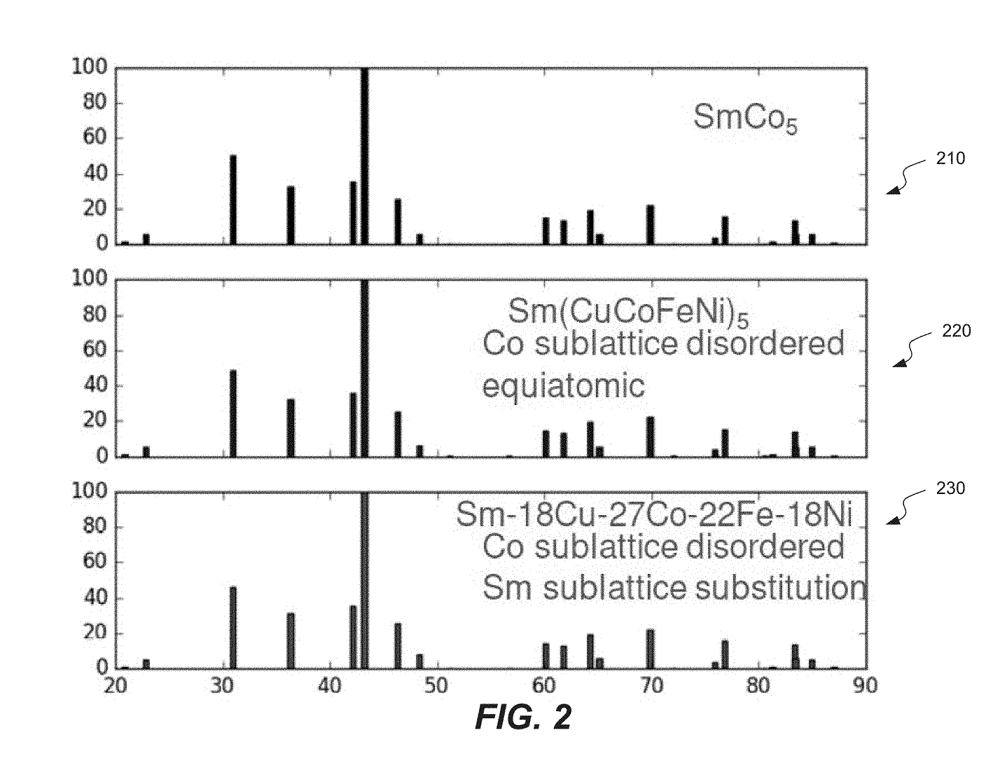

FIG. 2 illustrates simulations of X-ray Diffraction (XRD) spectra for three different compositions. Specifically, XRD spectra 210 corresponds to a conventional SmCo₅ magnet. XRD spectra 220 corresponds to an IPARE magnet with equiatomic compositions of cobalt, copper, iron, and nickel. Finally, XRD spectra 220 corresponds to an IPARE magnet with a higher cobalt content. The spectra are very similar suggesting similar crystal structures and lattice spacings.

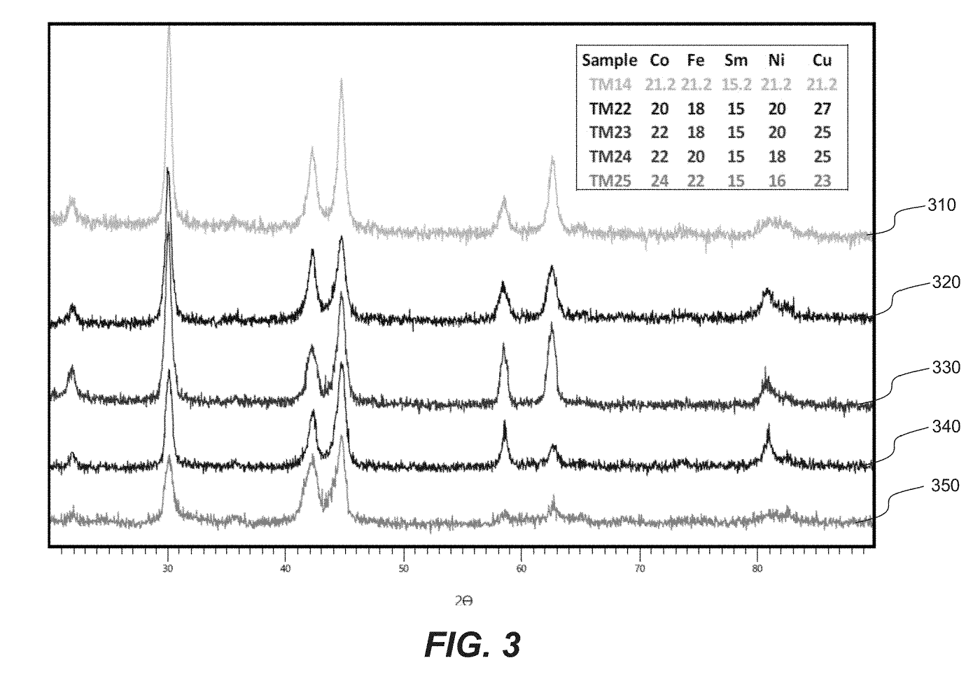

FIG. 3 illustrates diffraction spectra for five alloys having different compositions. Specifically, the diffraction spectra show the structure being identical for a wide range of compositions. Line 310 corresponds to 21.2 atomic % of cobalt, 21.2 atomic % of iron, 15.2 atomic % of samarium, 21.2 atomic % of nickel, and 21.2 atomic % of copper. Line 320 corresponds to 20 atomic % of cobalt, 18 atomic % of iron, 15 atomic % of samarium, 20 atomic % of nickel, and 27 atomic % of copper. Line 330 corresponds to 22 atomic % of cobalt, 18 atomic % of iron, 15 atomic % of samarium, 20 atomic % of nickel, and 25 atomic % of copper. Line 340 corresponds to 22 atomic % of cobalt, 20 atomic % of iron, 15 atomic % of samarium, 18 atomic % of nickel, and 25 atomic % of copper. Finally, line 350 corresponds to 20 atomic % of cobalt, 18 atomic % of iron, 15 atomic % of samarium, 20 atomic % of nickel, and 27 atomic % of copper. The structure being identical for a wide range of compositions is a key to the IPARE magnets. Despite slightly changing the composition (within 5 atomic % for each element), the uniaxial structure is maintained, identically (meaning same crystal structure, same lattice spacing). Furthermore, the crystal structure is that of a Cu5Ca structure.

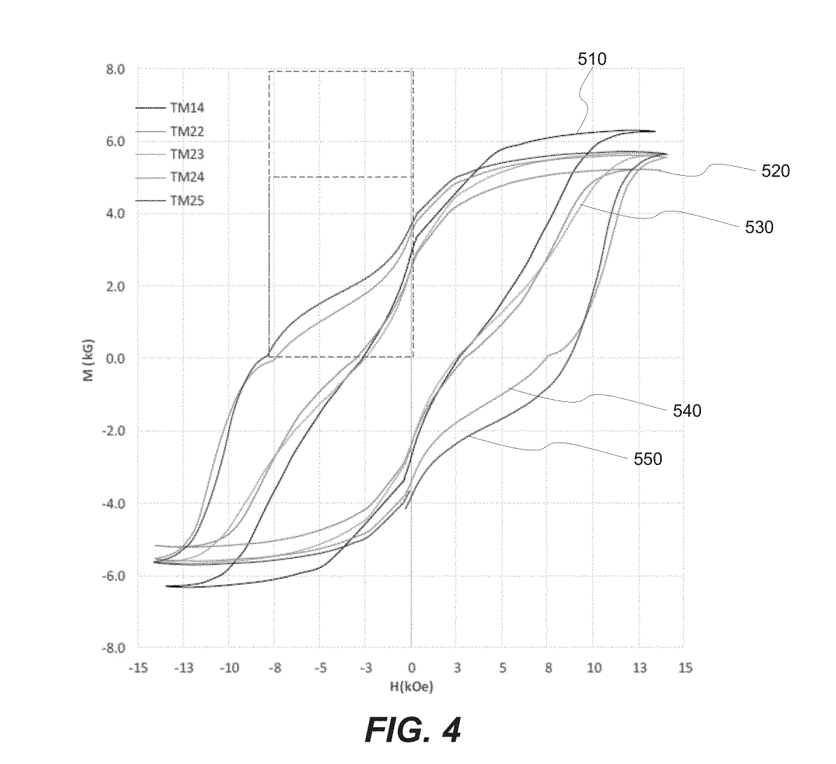

FIG. 4 illustrates high coercivity properties of five different alloys. The compositions of different samples and corresponding saturation magnetization (Ms) are presented in Table 1 below.

TABLE 1

| | Alloy | Cobalt, | Iron, | Samarium, | Nickel, | Copper, | Ms, |
|---|---|---|---|---|---|---|---|
| Line | Name | at % | at % | at % | at % | at % | Tesla |
| 510 | TM14 | 21.21 | 21.21 | 15.15 | 21.21 | 21.21 | 0.98 |
| 520 | TM22 | 20.00 | 18.00 | 15.00 | 20.00 | 27.00 | 0.89 |
| 530 | TM23 | 22.00 | 18.00 | 15.00 | 20.00 | 25.00 | 0.93 |
| 540 | TM24 | 22.00 | 20.00 | 15.00 | 18.00 | 25.00 | 0.96 |
| 550 | TM25 | 24.00 | 22.00 | 15.00 | 16.00 | 23.00 | 1.03 |

There is a substantial increase in coercivity between TM23 and TM24/25 alloys. By varying the amount of individual transition metal components, different values of magnetic properties can be achieved, intrinsically, while maintaining the same basic microstructure and crystallographic properties.

In FIG. 4, the smaller dashed box represents a magnetic maximum energy product of 12 MGOe with no optimization except squaring the hysteresis curve. The larger dashed box represents a magnetic maximum energy product of 16 MGOe for optimized BR.

Another set of tests has been performed with 16 atomic % of samarium. The calculated (predicted) isotropic results are presented in Table 2 below.

TABLE 2

| Alloy | Cobalt, | Iron, | Samarium, | Nickel, | Copper, | Ms, | BHₘₐₓ |
|---|---|---|---|---|---|---|---|
| Name | at % | at % | at % | at % | at % | Tesla | MGOe |
| TM36 | 21 | 21 | 16 | 21 | 21 | 0.98 | 9.53 |
| TM37 | 22 | 22 | 16 | 19 | 21 | 1.01 | 10.12 |
| TM44 | 24 | 23 | 16 | 19 | 18 | 1.05 | 10.94 |
| TM51 | 25 | 24 | 16 | 18 | 17 | 1.11 | 12.23 |

All alloy samples had a two-phase structure consisting of a bcc dendritic precipitation (henceforth, “B-phase”) of ˜Fe₅Co₃ composition and an hcp (“H-phase”) of Co—Cu—Fe—Ni—Sm of variable composition. The Fe—Co phase contained no measurable Sm, but did have a small amount of Cu and Ni, in the form of nm-scale Cu—Ni precipitates. It was observed that for less than 15 atomic % Sm, the coercivity was very low. In 15 and 16 atomic % Sm alloys, the Sm was completely segregated to the H-phase. The relative volumes of the H-phase and B-phase was calculated based on the scanning electron microscope (SEM) images per sample and three samples per composition. The field of view (FOV) was 500 μm on all images. Table 3 presented below summarizes the compositions (measured by EDS) of the H-phase and the predicted magnetic properties based on the compositions.

TABLE 3

| Alloy | Cobalt, | Iron, | Samarium, | Nickel, | Copper, | Ms, | % HCP | BHₘₐₓ |
|---|---|---|---|---|---|---|---|---|
| Name | at % | at % | at % | at % | at % | Tesla | present | MGOe |
| TM36 | 20 | 16 | 18 | 19 | 27 | 0.84 | 84 | 9.53 |
| TM37 | 21 | 15 | 18 | 25 | 21 | 0.88 | 90 | 10.12 |
| TM44 | 23 | 20 | 17 | 20 | 20 | 0.99 | 95 | 10.94 |
| TM51 | 25 | 22 | 17 | 19 | 17 | 1.07 | 97 | 12.23 |

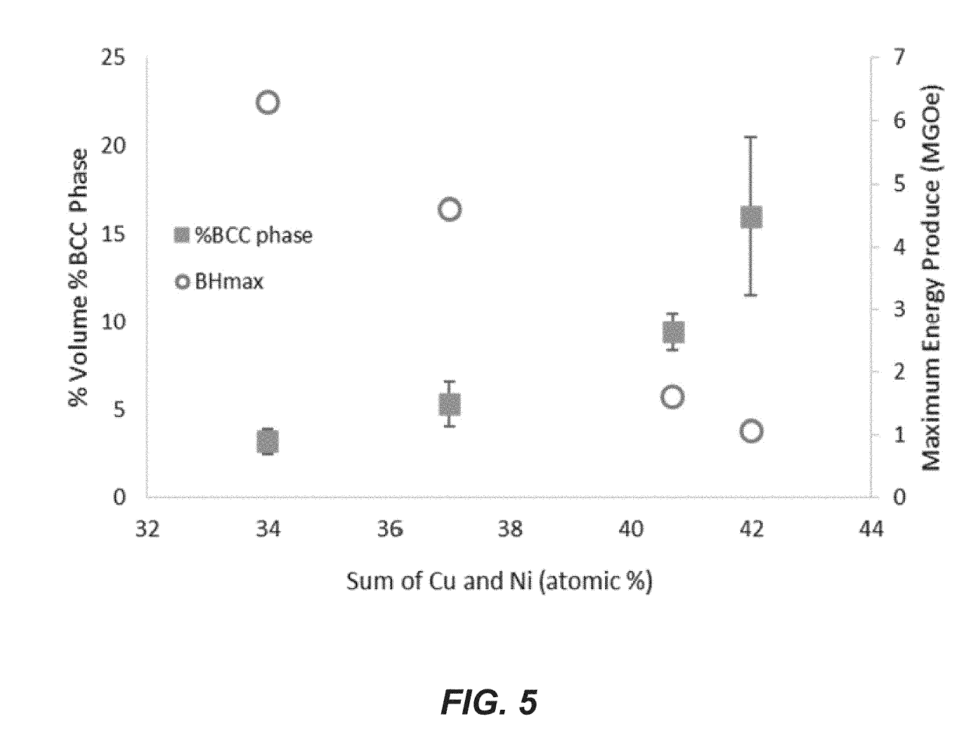

Comparing Table 2 and Table 3, it can be seen that the higher the Co and Fe (or alternatively lower Cu and Ni) content, the closer the H-phase composition is to the nominal composition. This was observed with 15 atomic % Sm compositions as well. Alternatively, the volume fraction of B-phase is reduced for e.g. lower Cu and Ni concentrations, thus the segregated H-phase is closer to the nominal composition. In any case, one of the difficulties of dealing with a 5 principle-component system is correlating composition effect with alloys properties. However, one trend is observed when plotting the sum of Cu and Ni vs. volume fraction of B-phase and BHₘₐₓ, which can be seen in FIG. 5.

A TEM analysis showed an interfacial region in the B-phase that is devoid of Cu. The Cu concentration is subsequently increased in the interface of H-phase grain. Along with the increase in Cu, there is a decrease in Fe and Co in the interfacial region of the H-phase. Additionally, there appear to be Cu-rich precipitates in the B-phase on the order of 10 nm, one of the larger precipitates appears to be Ni rich, but overall the intensity of Ni and Sm appear to be uniform (there is no Sm in the B-phase). Crystallinity of both the B and H-phase were observed with the interface appeared to be amorphous.

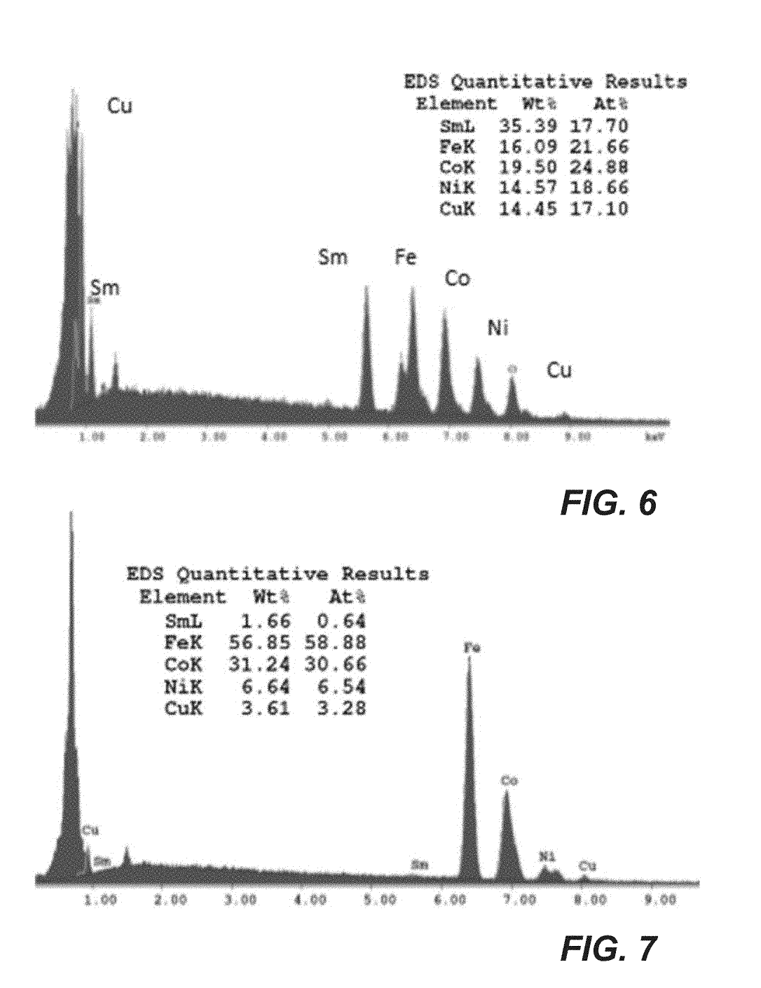

The composition characterization technique used EDS in an SEM. Typically, an alloy has composition taken at 5 locations with an analysis area of ˜10 μm×10 μm. If contrast is seen within the H-phase, then a point analysis is done in the contrasting areas. The variation in composition from location to location was about 5% relative (i.e. 20 atomic %±1 atomic %) which is within the limit of the EDS accuracy. Thus, it is possible that there were some variations of composition from grain to grain in the H-phase, but these variations could not be determined crystallographically. An example of composition analysis of TM51 sample at two locations is shown for reference in FIGS. 6 and 7. The sample was polished with a final step of 2 μm diamond paste. Some polishing residue and scratches were observed. A limitation of using micro probe EDS is that the material is characterized only within a few microns of the surface. However, the samples were sawn from the ingot. As such, a good representation (excluding surface effects) is obtained by EDS analysis of the cross-section face.

Phase analysis and crystallography on this system was performed using x-ray diffraction (XRD) and transmission electron diffraction. For alloys containing 15 and 16 atomic % Sm, the two formed phases were always crystallographically similar enough as to be considered identical and were matching to SmCo₅ (using Rietveld refinement techniques with a χ²=7×10⁻⁶). The XRD spectra of alloy containing 12, 15, 16, and 17 atomic % Sm were also similar to SmCo₅.

Comparison of crystallographic data for different alloys samples revealed little variations in the peak positions of the spectra. This suggests that within a finite range of the four transition metals around 21 atomic %, there is a stable volume in phase space in which the SmCo₅ crystal structure exists. A 5-component system, with a fixed concentration of Sm, can be visualized as a 3-dimensional volume, because the sum of the 4 transition metals is constrained by 1-n, i.e., the concentration of 4 transition metals has to add up to 1—the fraction of Sm. That represents a stable phase with the CaCu₅ canonical structure. Additionally, if one allows the Sm to vary between e.g. 12 and 17 atomic %, this system forms a tesseract in 4-space. Based on the 40 odd alloys that have been tested in their bulk form, the H-phase data would allow construction of such a phase diagram, although visualization of this phase diagram is complicated.

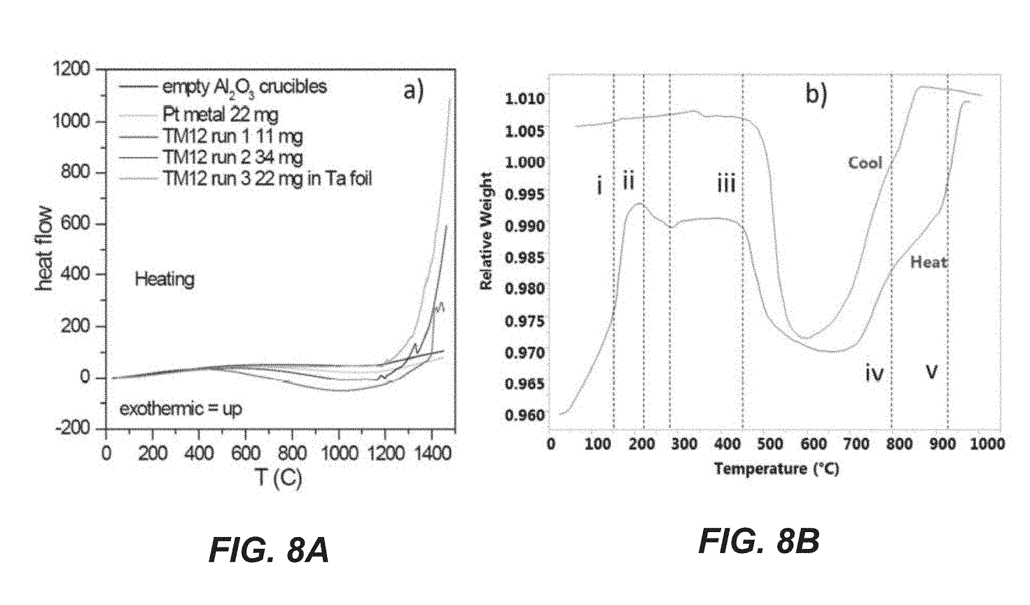

The phase diagram of the binary Sm—Co shows a eutectoid reaction at 812° C., whereupon the composition SmCo₅ decomposes into Sm₂Co₁₇ and Sm₅Co₁₉. This has significant consequences for the industrial production of Sm—Co magnets. Essentially, because the desirability of the high coercivity associated with the 1-5 phase, processing SmCo₅ requires specific temperature control which adds cost, complexity, and process constraints to circumvent the eutectoid. Curie temperatures and any phase transformations were determined using differential gravimetric calorimetry (with a magnetic field) and differential scanning calorimetry. The experimental data is presented in FIGS. 8A and 8B. The DSC data shows no eutectoid or melting temperature below 1400° C. demonstrating the stability of the (IPARE) 1-5 phase based on Sm, Co, Fe, Cu, and Ni. From the DGA data, the Curie temperatures for (the IPARE) SmCo₅ was compatible with the inflection point at iv in FIG. 8B and for Fe—Co the point at v agrees well with data from the Fe—Co phase diagram. However, the points labeled ii and iii seem to indicate an increase in magnetic susceptibility. Point iii has been reproduced in temperature variable temperature M-H data (as seen in the following sections). The point labeled i could be from the Cu rich interface and would be similar to data in the literature on Cu-rich Sm[CoCu]₅ alloys.

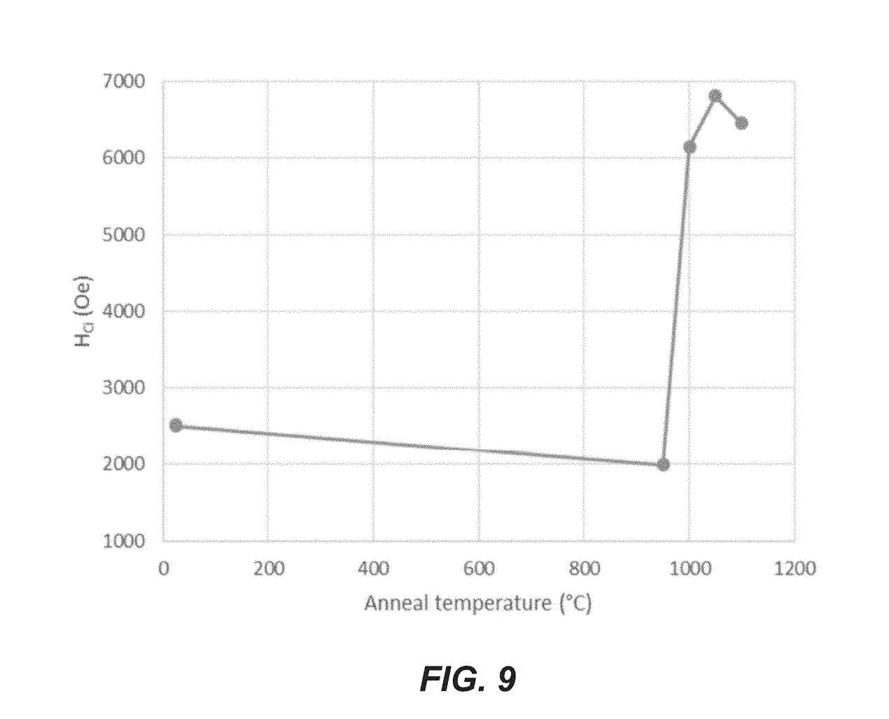

Unlike for conventional SmCo₅, no quenching or secondary heat treatment was needed for optimization. FIG. 9 shows the result of an annealing experiment for one of alloys listed above. The annealing temperature for most of alloys is selected to be between 1000 and 1100° C., while the duration is about 1 hr. The samples were annealed in an evacuated quartz tube, backfilled with flowing forming gas at 100 Torr.

The magnetization of the 16 atomic % Sm alloys will now be described. For TM36 and TM37, the presence of a high Cu concentration in the H-phase seems to be associated with the demagnetization curve being non-square. When the sum of Cu and Ni was below ˜40 atomic % (and neither one is greater than 20 atomic %) the 2^{nd} quadrant behavior becomes quite square.

In the unannealed state, the virgin magnetization curves of all four alloys demonstrate a nucleation controlled magnetization. After annealing, TM37 and 36 still displayed nucleation controlled magnetization, but TM44 and TM51 have changed to a pinning controlled magnetization. It would appear that although the 1-5 structure is common to all alloys, the magnetization mechanism depends on small variations in composition. The effect of annealing on coercivity for TM36 and 37 is roughly a two-fold increase, whereas the increase in coercivity for TM44 and TM51 is almost three-fold.

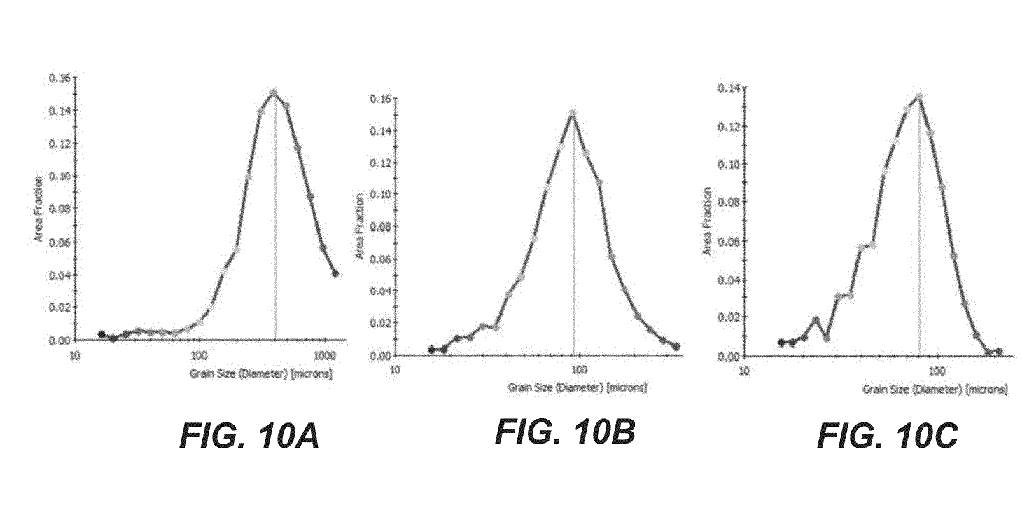

The magnetization behavior of the cast alloys negatively impacted by an overly large grain size. The cast alloys tested herein show a strong dependence of grain size on composition. The compositional dependence of grain size and H-phase introduces a difficulty into identifying the mechanism responsible for magnetic performance. FIGS. 10A-10C shows this clear dependence of composition on grain size. Specifically, FIG. 10A represents—a) TM36 (equiatomic in transition metals). FIG. 10B represents TM44 (Co rich or Ni+Cu poor). Finally, FIG. 10C represents TM51 (similar to TM44 but less Cu).

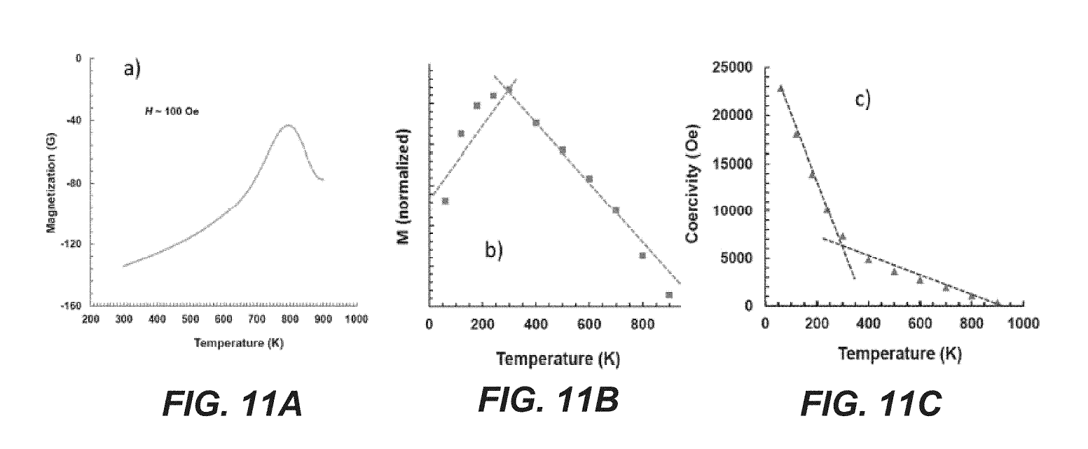

Dependence of magnetic properties on temperature is presented FIGS. 11A-11C. Specifically, FIG. 11A corresponds to magnetization at a bias field of −100 Oe, FIG. 11B—normalized remanence, and FIG. 11C—intrinsic coercivity (Ho). Alloy samples were measured on a VSM with temperature control from 50-900 K. The onset of this feature may be associated with a coupling of two phases, thus increasing the magnetic susceptibility. However, no Curie temperature effects were observed up to 900 K (600° C.), thus it is likely that the Curie temperature is between 700 and 800° C. (as noted above). It does not seem to affect the remanence or the coercivity. The temperature behavior of the remanence and the intrinsic coercivity, Ho are very unusual for Sm—Co alloys, although similar behavior in magnetization is seen in Nd—Fe—B. The effect of temperature on Ho has also been observed at low temperatures for 15 atomic % Sm alloys synthesized for this alloy class. As shown in FIG. 11C, H_{Ci} appears to be two different linear functions (although the behavior could be exponential) which would suggest a discontinuity in the first derivative of the magnetic energy. The opposite behavior is seen for the remanence below room temperature. Taken together this would suggest a first order phase transition occurs around 300 K. As there is virtually no atomic mobility at 300 K for these alloys (barring a martensitic transformation), this would suggest a magnetic coupling phenomenon or a multi-phase behavior where each phase has a different dependence of magnetism on temperature.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. An inverse phase allotrope rare earth magnet comprising:
cobalt, having a concentration of between about 17 atomic % and 27 atomic %;
iron;
copper;
nickel; and
samarium.

2. The inverse phase allotrope rare earth magnet of claim 1, wherein the inverse phase allotrope rare earth magnet is substantially free from zirconium.

3. The inverse phase allotrope rare earth magnet of claim 1, wherein the concentration of cobalt in the inverse phase allotrope rare earth magnet is between about 20 atomic % and 25 atomic %.

4. The inverse phase allotrope rare earth magnet of claim 1, wherein a concentration of iron in the inverse phase allotrope rare earth magnet is between about 18 atomic % and 24 atomic %.

5. The inverse phase allotrope rare earth magnet of claim 1, wherein a concentration of copper in the inverse phase allotrope rare earth magnet is between about 17 atomic % and 27 atomic %.

6. The inverse phase allotrope rare earth magnet of claim 1, wherein a concentration of nickel in the inverse phase allotrope rare earth magnet is between about 18 atomic % and 24 atomic %.

7. The inverse phase allotrope rare earth magnet of claim 1, wherein a concentration of samarium in the inverse phase allotrope rare earth magnet is between about 12 atomic % and 20 atomic %.

8. The inverse phase allotrope rare earth magnet of claim 1, wherein the inverse phase allotrope rare earth magnet is a solid solution.

9. The inverse phase allotrope rare earth magnet of claim 1, wherein the inverse phase allotrope rare earth magnet has a hexagonal or other uniaxial lattice structure.

10. The inverse phase allotrope rare earth magnet of claim 1, wherein the inverse phase allotrope rare earth magnet has a grain size of between about 100 nm and 10,000 nm.

11. A method of forming an inverse phase allotrope rare earth magnet, the method comprising:
forming a mixture comprising cobalt, iron, copper, nickel, and samarium,
wherein a concentration of cobalt in the mixture is between about 17 atomic % and 27 atomic %;
melting the mixture to form a molten alloy; and
quenching the molten alloy to form a solid structure of the inverse phase allotrope rare earth magnet.

12. The method of claim 11, wherein quenching the molten alloy comprises exposing the molten alloy to a magnetic field.

13. The method of claim 11, further comprising heat treating the solid structure of the inverse phase allotrope rare earth magnet.

14. The method of claim 11, further comprising machining the solid structure of the inverse phase allotrope rare earth magnet.

15. The method of claim 11, wherein the mixture is substantially free from zirconium.

16. The method of claim 11, wherein:
a concentration of iron in the inverse phase allotrope rare earth magnet is between about 18 atomic % and 24 atomic %,
a concentration of copper in the inverse phase allotrope rare earth magnet is between about 17 atomic % and 27 atomic %,
a concentration of nickel in the inverse phase allotrope rare earth magnet is between about 18 atomic % and 24 atomic %, and
a concentration of samarium in the inverse phase allotrope rare earth magnet is between about 12 atomic % and 20 atomic %.

17. The method of claim 11, wherein the inverse phase allotrope rare earth magnet is a solid solution.

18. The method of claim 11, wherein the inverse phase allotrope rare earth magnet has a hexagonal lattice structure or other uniaxial lattice structure.

19. The method of claim 11, wherein the inverse phase allotrope rare earth magnet has a grain size of between about 100 nm and 10,000 nm.

20. A component comprising:
an inverse phase allotrope rare earth magnet, comprising:
cobalt, having a concentration of between about 17 atomic % and 27 atomic %;
iron;
copper;
nickel; and
samarium,
wherein the component is one of a motor, a generator, a sensor, an actuator, a medical device, magnetic gears, magnetic bearings, magnetic separation equipment, acoustic devices, and holding and lifting equipment.
